(19) United States
(12) Patent Application Publication
(10) Pub. No.: US 2011/0160325 A1
(43) Pub. Date: Jun. 30, 2011

(54) METHOD FOR PRODUCING A VOID-CONTAINING RESIN MOLDED PRODUCT, AND VOID-CONTAINING RESIN MOLDED PRODUCT

(75) Inventors: Yasutomo Goto, Shizuoka (JP); Hiroki Saski, Shizuoka (JP); Tooru Ogura, Kanagawa (JP); Daisuke Arioka, Shizuoka (JP)

(73) Assignee: FUJIFILM CORPORATION, Tokyo (JP)

(21) Appl. No.: 13/061,399

(22) PCT Filed: Jul. 23, 2009
(86) PCT No.: PCT/JP2009/063208

§ 371 Date: Feb. 28, 2011

(30) Foreign Application Priority Data
Aug. 29, 2008 (JP) 2008-220777
Sep. 8, 2008 (JP) 2008-229463

(51) Int. Cl. B29C 55/02; C08F 110/06; C08G 63/183

(52) U.S. Cl. 521/143; 264/41; 521/182

(57) ABSTRACT

Described is a method for producing a void-containing resin molded product which enables producing a void-containing resin molded product having a high color saturation and an appearance excellent in brightness and heat insulation properties by stretching polymer-molded product containing a single crystalline polymer, and a void-containing resin molded product obtained by the production method. A first aspect of the method for producing a void-containing resin molded product is a method for producing a void-containing resin molded product, the method including: stretching a polymer-molded product containing a single crystalline polymer in at least one axial direction, wherein a yield stress (A) and a stress (L30) at an elongation of 30% in a stress-strain curve of the polymer-molded product in the stretching in the one axial direction satisfy Relationship (I):

L30/A<0.90 Relationship (I)

### TECHNICAL FIELD

1. Field of the Invention

The present invention relates to a method for producing a void-containing resin molded product using a polymer molded product containing a single crystalline polymer, and a void-containing resin molded product obtained by the production method.

2. Background Art

As a technique for producing a void-containing resin molded product, there have been known a technique of stretching a fabric-form or sheet-form product, which is obtained by mixing a thermoplastic resin with another thermoplastic resin insoluble in the thermoplastic resin, inorganic particles or organic particles in at least one axial direction (see, PTL 1, for example). However, the technique described in PTL 1 is a method in which a heterogeneous component is mixed in main components and the mixture is used as nuclei to thereby create voids.

As a technique for producing a biaxial polyester film by stretching, there have been known a technique of providing a polyester film with uniaxial orientation so that birefringence and density of the film satisfy a predetermined relationship (see PTL 2, for example), and a technique of using a film in which a ratio (de/dc) of an average thickness (dc) of an unstretched film at its center portion to a maximum thickness (de) of the unstretched film at its end portion is 3 or less (see PTL 3, for example).

However, the technique described in PTL 2 is a technique which enables increasing the speed of producing a film and the yield, and the technique described in PTL 3 is a technique for improving the productivity of a film and for producing a film having less nonuniformity in thickness and excellent in planarity. Both of them are not techniques for creating voids.

Therefore, it is desired to develop a method for producing a void-containing resin molded product to create voids by stretching a polymer molded product containing a single crystalline polymer.

### CITATION LIST

### Patent Literature

PTL 1 Japanese Patent Application Laid-Open (JP-A) No. 10-278160

PTL 2 Japanese Patent (JP-B) No. 3582677

PTL 3 Japanese Patent Application Laid-Open (JP-A) No. 09-295344

### SUMMARY OF INVENTION

The present invention aims to solve the above-mentioned various conventional problems and to achieve the following object. That is, an object of the present invention is to provide a method for producing a void-containing resin molded product which enables producing a void-containing resin molded product having a high color saturation and an appearance excellent in brightness and heat insulation properties, and a void-containing resin molded product obtained by the production method.

### Solution to Problem

Means for solving the above-mentioned problems are as follows:

<1> A method for producing a void-containing resin molded product, the method including:
stretching a polymer-molded product containing a single crystalline polymer in at least one axial direction,
wherein a yield stress (A) and a stress (L30) at an elongation of 30% in a stress-strain curve of the polymer-molded product in the stretching in the one axial direction satisfy Relationship (I) below:

L30/A<0.90 Relationship (I)

<2> A method for producing a void-containing resin molded product, the method including:
stretching a polymer-molded product containing a single crystalline polymer in at least one axial direction,
wherein a yield stress (A) and a stress (L40) at an elongation of 40% in a stress-strain curve of the polymer-molded product in the stretching in the one axial direction satisfy Relationship (II) below, and a stress (B) at a change point and the stress (L40) at the elongation of 40% in the stress-strain curve satisfy Relationship (III) below, where the change point is a point at which the stress starts rising for the first time after falling from the yield stress (A):

A>L40 Relationship (II)

B/L40≦1.40 Relationship (III)

<3> The method for producing a void-containing resin molded product according to one of <1> and <2> above, wherein the crystalline polymer is any one of polyolefin, polyester, and polyamide.

<4> A void-containing resin molded product obtained by the method for producing a void-containing resin molded product according to any one of <1> to <3> above.

### Advantageous Effects of Invention

The present invention can provide a method for producing a void-containing resin molded product which enables producing a void-containing resin molded product having a high color saturation and an appearance excellent in brightness and heat insulation properties, and a void-containing resin molded product obtained by the production method.

### BRIEF DESCRIPTION OF DRAWINGS

FIG. 1 is a view illustrating one example of a method for producing a void-containing resin molded product according to the present invention, and is a flow view of a biaxial stretching film production device.

FIG. 2A is a view for specifically illustrating an aspect ratio, and is a perspective view of a void-containing resin molded product.

FIG. 2B is a view for specifically illustrating an aspect ratio, and is a view of an A-A′ cross-section of the void-containing resin molded product in FIG. 2A.

FIG. 2C is a view for specifically illustrating an aspect ratio, and is a view of a B-B′ cross-section of the void-containing resin molded product in FIG. 2A.

FIG. 2D is a view for illustrating a method of measuring a distance of 10 voids closest to a film surface from the film surface, and is the A-A′ cross-section in FIG. 2A.

FIG. 3 is a graph illustrating a stress-strain curve of a polymer film of Example A-1.

FIG. 4 is a graph illustrating a stress-strain curve of a polymer film of Example A-2.

FIG. 5 is a graph illustrating a stress-strain curve of a polymer film of Example A-3.

FIG. 6 is a graph illustrating a stress-strain curve of a polymer film of Example A-4.

FIG. 7 is a graph illustrating a stress-strain curve of a polymer film of Comparative Example A-1.

FIG. 8 is a graph illustrating a stress-strain curve obtained in stretching a polymer film of Example B-1.

FIG. 9 is a graph illustrating a stress-strain curve obtained in stretching a polymer film of Example B-2.

FIG. 10 is a graph illustrating a stress-strain curve obtained in stretching a polymer film of Example B-3.

FIG. 11 is a graph illustrating a stress-strain curve obtained in stretching a polymer film of Comparative Example B-1.

FIG. 12 is a graph illustrating one examples of a stress-strain (elongation) curve and each stress.

### DESCRIPTION OF EMBODIMENTS

### Method for Producing a Void-Containing Resin Molded Product, and Void-Containing Resin Molded Product

A void-containing resin molded product according to the present invention can be favorably produced by the production method of the present invention. Hereinafter, a method for producing a void-containing resin molded product of the present invention and a void-containing resin molded product produced by the method will be described.

The method for producing a void-containing resin molded product of the present invention includes at least a step of stretching a polymer-molded product containing a single crystalline polymer in at least one axial direction (stretching step) and further includes other steps as required.

### [Stretching Step]

The stretching step is a step of stretching the polymer-molded product in at least one axial direction to create voids.

### <Polymer-Molded Product>

The polymer-molded product is formed of a polymer composition containing a single crystalline polymer and includes other components.

The shape of the polymer-molded product is not particularly limited and may be suitably selected in accordance with the intended use. For example, a film-form and a sheet shape are exemplified.

### —Polymer Composition—

The polymer composition contains a single crystalline polymer, and when necessary, contains other components not contributing to creation of voids. It is particularly preferable that the polymer composition includes only a crystalline polymer.

### ——Crystalline Polymer——

Generally, polymers are categorized into polymer having crystallinity (crystalline polymer) and non-crystalline (amorphous) polymer. However, even polymer having crystallinity is not a 100% crystallinity polymer and contains, in its molecular structure, crystalline regions where long-chain molecules are arranged in a regular manner and non-crystalline (amorphous) regions where molecules are not regularly arranged.

Therefore, the crystalline polymer in the polymer-molded product of the present invention is sufficient to contain at least the crystalline regions in its molecular structure and may include the crystalline regions and amorphous regions in a mixed manner.

The crystalline polymer is not particularly limited and may be suitably selected in accordance with the intended use. Examples thereof include high-density polyethylene, polyolefins (e.g., polypropylene, polyethylene, ethylene-vinyl acetate copolymers, ethylene-vinyl alcohol copolymers, ethylene-cycloolefin copolymers, polybutene-1, and poly-4-methyl pentene-1); polyamides (PA) (e.g., Nylon-6); polyacetals (POM); polyesters (e.g., PET, PEN, PTT, PBT, PPT, PHT, PBN, PES, and PBS), syndiotactic polystyrene (SPS); polyphenyrene sulfides (PPS); polyether ether ketones (PEEK); liquid crystal polymers (LCP); and fluorine resins. Among these, from the viewpoint of dynamic strength and productivity, polyolefins, polyesters, polyamides, syndiotactic polystyrene (SPS), and liquid crystal polymers (LCP) are preferable, with the polyolefins, polyesters and polyamides being particularly preferable.

The melt viscosity of the crystalline polymer is not particularly limited and may be suitably selected in accordance with the intended use. It is, however, preferably 50 Pa·s to 700 Pa·s, more preferably 70 Pa·s to 500 Pa·s, and particularly preferably 80 Pa·s to 300 Pa·s. When the melt viscosity is 50 Pa·s to 700 Pa·s, it is preferable in that the shape of a melt film discharged from a die head is stabilized in melt-film formation, and a film is uniformly formed with ease. Further, when the melt viscosity is 50 Pa·s to 700 Pa·s, it is preferable in that the viscosity of a melt film at the time of melt film formation is appropriate, the melt film is easily extruded, and a melt film is leveled in the film formation, thereby concave-convexes can be reduced.

Here, the melt viscosity can be measured by a plate-type rheometer or a capillary rheometer.

MFR (Melt Flow Rate) of the crystalline polymer is not particularly limited and may be suitably selected in accordance with the intended use. It is, however, preferably 0.1 (g/10 min) to 100 (g/10 min), more preferably 0.5 (g/10 min) to 60 (g/10 min), and particularly preferably 1 (g/10 min) to 35 (g/10 min). When the MFR is 1 (g/10 min) to 35 (g/10 min), it is preferable in that the strength of the formed film is increased and the film can be efficiently stretched.

Here the MFR can be measured, for example, by SEMI-AUTO MELT INDEXA 2A (manufactured by Toyo Seiki Co., Ltd.)

The melting point (Tm) of the crystalline polymer is not particularly limited and may be suitably selected in accordance with the intended use. It is, however, preferably 100° C. to 350° C., more preferably 100° C. to 300° C., and particularly preferably 100° C. to 260° C. When the melting point is 40° C. to 350° C., it is preferable in that the shape of the film in a temperature range at which the film is expected to be commonly used is easily maintained and in that a film is uniformly formed without using a special technique required for processing at high temperature.

Here, the melting point can be measured by a differential scanning calorimeter (DSC).

### ———Polyester Resin———

The polyesters (which may be referred to as “polyester resin”, hereinbelow) are collectively polymer compounds containing an ester bond as a primary bond chain of the main chain. Therefore, preferred polyester resins as the crystalline polymer include not only the exemplarily mentioned PET (polyethylene terephthalate), PEN (polyethylene naphthalate), PTT (polytrimethylene terephthalate), PBT (polybutylene terephthalate), PPT (polypentamethylene terephthalate), PHT (polyhexamethylene terephthalate), PBN (polybutylene naphthalate), PES (polyethylene succinate), and PBS (polybutylene succinate), but also all polymer compounds obtained by polycondensation reaction between a dicarboxylic acid component and a diol component.

The dicarboxylic acid component is not particularly limited and may be suitably selected in accordance with the intended use. Examples thereof include aromatic dicarboxylic acids, aliphatic dicarboxylic acids, alicyclic dicarboxylic acids, oxycarboxylic acids, and polyfunctional acids. Among these, aromatic dicarboxylic acids are preferable.

Examples of the aromatic dicarboxylic acids include terephthalic acid, isophthalic acid, diphenyl dicarboxylic acid, diphenyl sulfone dicarboxylic acid, naphthalene dicarboxylic acid, diphenoxyethane dicarboxylic acid, and sodium-5-sulfoisophthalic acid. Among these, terephthalic acid, isophthalic acid, diphenyl dicarboxylic acid, and naphthalene dicarboxylic acid are preferable, with the terephthalic acid, diphenyl dicarboxylic acid, and naphthalene dicarboxylic acid being more preferable.

Examples of the aliphatic dicarboxylic acids include oxalic acid, succinic acid, eicosanoic acid, adipic acid, sebacic acid, dimer acid, dodecanedioic acid, maleic acid, and fumaric acid. Examples of the alicyclic dicarboxylic acids include cyclohexane dicarboxylic acid. Examples of the oxycarboxylic acids include p-oxybenzoic acid. Examples of the polyfunctional acids include trimellitic acid, and pyromellitic acid. Among the aliphatic dicarboxylic acids and alicyclic dicarboxylic acids, succinic acid, adipic acid and cyclohexane dicarboxylic acid are preferable, with the succinic acid and adipic acid being more preferable.

The diol component is not particularly limited and may be suitably selected in accordance with the intended use. Examples thereof include aliphatic diol, alicyclic diol, aromatic diol, diethylene glycol, and polyalkylene glycol. Among these, aliphatic diol is preferable.

Examples of the aliphatic diol include ethylene glycol, propane diol, butane diol, pentane diol, hexane diol, neopentyl glycol, and triethylene glycol. Among these, propane diol, butane diol, pentane diol and hexane diol are particularly preferable. Examples of the alicyclic diol include cyclohexane dimethanol. Examples of the aromatic diol include bisphenol A, and bisphenol S.

The melt viscosity of the polyester resin is not particularly limited and may be suitably selected in accordance with the intended use. It is, however, preferably 50 Pa·s to 700 Pa·s, more preferably 70 Pa·s to 500 Pa·s, and particularly preferably 80 Pa·s to 300 Pa·s. The greater the melt viscosity, the more easily voids are created at the time of stretching. When the melt viscosity is 50 Pa·s to 700 Pa·s, it is preferable in that a melt film is easily extruded in film formation, the flow of resin is stabilized and thus retention of the resin hardly occur and the quality of the film is stabilized. Further, when the melt viscosity is 50 Pa·s to 700 Pa·s, it is preferable in that the film is uniformly stretched with ease because the stretching tension of the film is appropriately maintained at the time of stretching, and thus rupture hardly occur. In addition, when the melt viscosity is 50 Pa·s to 700 Pa·s, it is preferable in that the shape of a melt film discharged from a die head at the time of film formation is easily maintained, the melt film can be stably molded, and the physical properties of the molded product are increased, such as the molded product is hardly broken.

The limiting viscosity (IV) of the polyester resin is not particularly limited and may be suitably selected in accordance with the intended use. It is, however, preferably 0.4 to 1.2, more preferably 0.6 to 1.0, and particularly preferably 0.7 to 0.9. The greater the IV, the more easily voids are created at the time of stretching. When the IV of the polyester resin is 0.4 to 1.2, a melt film is easily extruded in film formation, the flow of resin is stabilized and thus retention of the resin hardly occur and the quality of the film is stabilized. Further, when the IV of the polyester resin is 0.4 to 1.2, it is preferable in that the film is uniformly stretched with ease because the stretching tension of the film is appropriately maintained at the time of stretching, and burden is hardly applied to the stretching machine. In addition, when the IV of the polyester resin is 0.4 to 1.2, it is preferable in that he molded product is hardly broken and thus the physical properties of the molded product are increased.

Here, the IV can be measured by a Ubbelohde viscometer.

The melting point of the polyester resin is not particularly limited and may be suitably selected in accordance with the intended use. From the viewpoints of the heat resistance and film formability, it is, however, preferably 150° C. to 300° C., and more preferably 160° C. to 270° C.

### ———Polyolefin Resin———

The polyolefin (which may be, hereinafter, referred to as “polyolefin resin”) means a polymer obtained by polymerization of α-olefin containing ethylene as a basic component. Examples of the polyolefin resin suitable as the crystalline polymer are, as described above, polypropylene, polyethylene, ethylene-vinyl acetate copolymers, ethylene-vinyl alcohol copolymers, ethylene-cycloolefin copolymers, polybutene-1, poly-4-methylpentene-1. Among these, polyethylene and polypropylene are more preferable, with the polypropylene being particularly preferable.

The melt viscosity of the polyolefin resin is not particularly limited and may be suitably selected in accordance with the intended use. It is, however, preferably 50 Pa·s to 700 Pa·s, more preferably 70 Pa·s to 500 Pa·s, and particularly preferably 80 Pa·s to 300 Pa·s. The greater the melt viscosity, the more easily voids are created at the time of stretching. When the melt viscosity is 50 Pa·s to 700 Pa·s, it is preferable in that a melt film is easily extruded in film formation, the flow of resin is stabilized and thus retention of the resin hardly occur and the quality of the film is stabilized. Further, when the melt viscosity is 50 Pa·s to 700 Pa·s, it is preferable in that the film is uniformly stretched with ease because the stretching tension of the film is appropriately maintained at the time of stretching, and thus rupture hardly occur. In addition, when the melt viscosity is 50 Pa·s to 700 Pa·s, it is preferable in that the shape of a melt film discharged from a die head at the time of film formation is easily maintained, the melt film can be stably molded, and the physical properties of the molded product are increased, such as the molded product is hardly broken.

The MFR (Melt Flow Rate) of the polyolefin resin is not particularly limited and may be suitably selected in accordance with the intended use. It is, however, preferably 0.1 (g/10 min) to 100 (g/10 min), more preferably 0.5 (g/10 min) to 50 (g/10 min), and particularly preferably 1 (g/10 min) to 35 (g/10 min). The greater the MFR, the more easily voids are created at the time of stretching. When the MFR is 0.1 (g/10 min) to 100 (g/10 min), a melt film is easily extruded in film formation, the flow of resin is stabilized and thus retention of the resin hardly occur and the quality of the film is stabilized. Further, when the MFR is 0.5 (g/10 min) to 50 (g/10 min), it is preferable in that the film is uniformly stretched with ease because the stretching tension of the film is appropriately maintained at the time of stretching, and burden is hardly applied to the stretching machine. In addition, when the MFR is 1 (g/10 min) to 35 (g/10 min), it is preferable in that the molded product is hardly broken and thus the physical properties of the molded product are increased.

The melting point of the polyolefin resin is not particularly limited and may be suitably selected in accordance with the intended use. From the viewpoints of heat resistance and film formability, it is, however, preferably 150° C. to 300° C., and more preferably 160° C. to 270° C.

—Polyamide Resin—

The polyamide (which may be, hereinbelow, referred to as “polyamide resin”) means a polymer obtained by binding a number of monomers through an amide bond. Examples of the polyamide resin suitable as the crystalline polymer are nylon, and aramid resin. Among these, nylon is preferable.

The melt viscosity of the polyamide resin is not particularly limited and may be suitably selected in accordance with the intended use. It is, however, preferably 50 Pa·s to 700 Pa·s, more preferably 70 Pa·s to 500 Pa·s, and particularly preferably 80 Pa·s to 300 Pa·s. The greater the melt viscosity, the more easily voids are created at the time of stretching. When the melt viscosity is 50 Pa·s to 700 Pa·s, it is preferable in that a melt film is easily extruded in film formation, the flow of resin is stabilized and thus retention of the resin hardly occur and the quality of the film is stabilized. Further, when the melt viscosity is 50 Pa·s to 700 Pa·s, it is preferable in that the film is uniformly stretched with ease because the stretching tension of the film is appropriately maintained at the time of stretching, and thus rupture hardly occur. In addition, when the melt viscosity is 50 Pa·s to 700 Pa·s, it is preferable in that the shape of a melt film discharged from a die head at the time of film formation is easily maintained, the melt film can be stably molded, and the physical properties of the molded product are increased, such as the molded product is hardly broken.

The MFR (Melt Flow Rate) of the polyamide resin is not particularly limited and may be suitably selected in accordance with the intended use. It is, however, preferably 0.1 (g/10 min) to 100 (g/10 min), more preferably 0.5 (g/10 min) to 60 (g/10 min), and particularly preferably 1 (g/10 min) to 20 (g/10 min). The greater the MFR, the more easily voids are created at the time of stretching. When the MFR is 0.1 (g/10 min) to 100 (g/10 min), a melt film is easily extruded in film formation, the flow of resin is stabilized and thus retention of the resin hardly occur and the quality of the film is stabilized. Further, when the MFR is 0.5 (g/10 min) to 60 (g/10 min), it is preferable in that the film is uniformly stretched with ease because the stretching tension of the film is appropriately maintained at the time of stretching, and burden is hardly applied to the stretching machine. In addition, when the MFR is 1 (g/10 min) to 20 (g/10 min), it is preferable in that he molded product is hardly broken and thus the physical properties of the molded product are increased.

The melting point of the polyamide resin is not particularly limited and may be suitably selected in accordance with the intended use. From the viewpoints of heat resistance and film formability, it is, however, preferably 150° C. to 300° C., and more preferably 160° C. to 270° C.

### ——Other Components——

The other components are not particularly limited, as long as they are components which do not contribute to the creation of voids, and may be suitably selected in accordance with the intended use.

Examples of the components which do not contribute to the creation of voids are heat resistant stabilizer, antioxidants, organic lubricants, nucleating agents, dyes, pigments, dispersants, coupling agents, and fluorescent whitening agents. Whether or not the other components contribute to the creation of voids can be distinguished whether components other than crystalline polymer (e.g., the after-mentioned components) can be detected inside voids or in interface portions of voids.

The antioxidants are not particularly limited and may be suitably selected in accordance with the intended use. Examples thereof include conventionally known hindered phenols. Examples of the hindered phenols are antioxidants commercially available under the trade names of IRGANOX 1010, IRGANOX SUMILIZER BHT, and IRGANOX SUMILIZER GA-80.

In addition, the antioxidant is used as a primary antioxidant, and a secondary antioxidant can also be used in combination. Examples of the secondary antioxidant include antioxidants commercially available under the trade names of SUMILIZER TPL-R, SUMILIZER TPM, and SUMILIZER TP-D.

The fluorescent whitening agents are not particularly limited and may be suitably selected in accordance with the intended use. As the fluorescent whitening agents are those commercially available under the trade names of UBITECH, OB-1, TBO, K-COL, KAYALIGHT, LUCOPUA, and EGM can be used. Note that these fluorescent whitening agents may be used alone or in combination. By adding the fluorescent whitening agents, it is possible to impart more brilliant and bluing whiteness to the resulting film and add a quality appearance thereto.

### <Stretching>

In the stretching, the polymer-molded product is stretched in at least one axial direction. Then, through the stretching step, with the polymer-molded product being stretched, voids oriented along the one axial direction are formed inside the polymer-molded product, thereby a void-containing resin molded product can be obtained.

The reason why voids are formed by stretching can be considered as follows: a single crystalline polymer constituting the polymer-molded product forms microscopic crystalline regions or microscopic regions having regularity at a certain molecular level, and the crystalline polymer is separately stretched in such a form that interfacial resins including crystalline or superfine structural regions which are hardly stretched at the time of stretching are torn apart, which causes the creation of voids.

The conditions for the stretching can be determined according to the aspect of the method for producing a void-containing resin molded product of the present invention.

A first aspect of the conditions for stretching (which may be, hereinbelow, referred to as “stretching conditions according to the first aspect”) can be determined depending on the relationship between a yield stress (A) and a stress (L30) at an elongation of 30% in a stress-strain (elongation) curve of the polymer-molded product in the first axial stretching.

As the method of measuring (calculation method) of the stress, it can be determined by a method described in JIS K 7127.

As the method of measuring the strain (elongation), it can be determined by a method described in JIS K 7127.

The stretching conditions according to the first aspect are not particularly limited, as long as the yield stress (A) and the stress (L30) at an elongation of 30% in the stress-strain (elongation) curve of the polymer-molded product in the stretching in the one axial direction satisfy the following Relationship (I), and may be suitably selected in accordance with the intended use. However, the relationship is preferably L30/A<0.80, and more preferably L30/A<0.75.

L30/A<0.90 Relationship (I)

When the value of L30/A is 0.90 or greater, the film may be stretched with the film being kept transparent, with creation of no void. In contrast, when the value of L30/A is within the more preferable range, it is advantageous in that voids are created, and the polymer molded product has further excellent stretchability.

A second aspect of the conditions for stretching (which may be, hereinbelow, referred to as “stretching conditions according to the second aspect”) can be determined depending on a relationship between the yield stress (A) and a stress (L40) at an elongation of 40% in the stress-strain (elongation) curve of the polymer-molded product in the stretching in the one axial direction and a relationship between a stress (B) at a change point and the stress (L40) at the elongation of 40% in the stress-strain curve satisfy Relationship (III) below, where the change point is a point at which the stress starts rising for the first time after falling from the yield stress (A).

As the method of measuring (calculation method) of the stress, it can be determined by a method described in JIS K 7127.

As the method of measuring the strain (elongation), it can be determined by a method described in JIS K 7127.

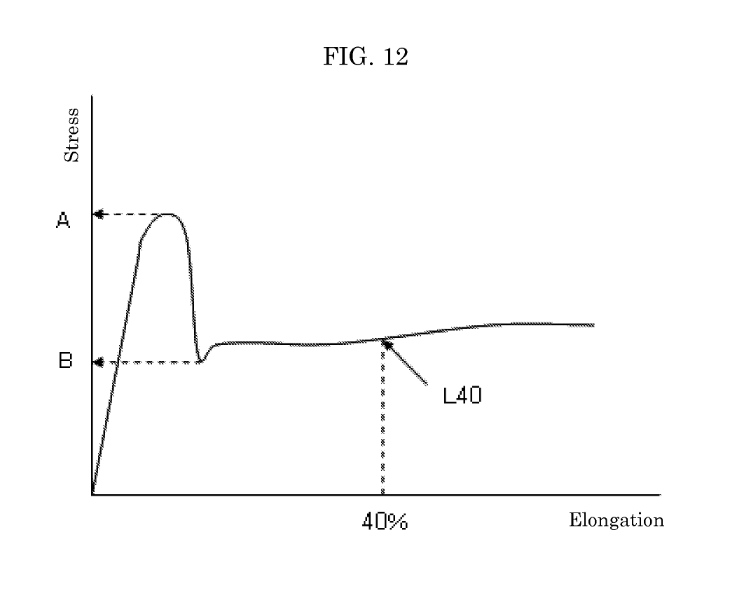

FIG. 12 shows one example of a stress-strain (elongation) curve and illustrates each stress.

In FIG. 12, A denotes a yield stress; B denotes a stress at a change point at which the stress starts rising for the first time after falling from the yield stress (A); and L40 denotes a stress at an elongation of 40%.

The stretching conditions according to the second aspect are not particularly limited as long as a yield stress (A) and a stress (L40) at an elongation of 40% in the stress-strain curve of the polymer-molded product in the stretching in the one axial direction satisfy Relationship (II) below, and a stress (B) at a change point and the stress (L40) at the elongation of 40% in the stress-strain curve satisfy Relationship (III) below, where the change point is a point at which the stress starts rising for the first time after falling from the yield stress (A):

A>L40 Relationship (II)

B/L40≦1.40 Relationship (III)

The value of A>L40 is not particularly limited and may be suitably selected in accordance with the intended use. However, the value of L40/A is preferably 1 to 0.3, more preferably 0.9 to 0.4, and particularly preferably 0.8 to 0.5.

When the value of L40/A is 1 or greater, voids may not be formed. In contrast, when the value of L40/A is within the particularly preferable range, it is advantageous in formation of voids.

The value of B/L40 is not particularly limited, as long as it is 1.40 or smaller, and may be suitably selected in accordance with the intended use. It is, however, preferably 1.1 or smaller, more preferably 1.0 or smaller, and particularly preferably 0.9 or smaller.

When the value of B/L40 is greater than 1.40, the film may be stretched with the film being kept transparent, with creation of no void. In contrast, when the value of B/L40 is within the particularly preferable range, it is advantageous in that voids are created, and the polymer molded product has further excellent stretchability.

The stretching method is not particularly limited, as long as the effects of the present invention are not impaired. Examples of the stretching method include uniaxial stretching, successive biaxial stretching, and simultaneous biaxial stretching. In any of these stretching methods, it is preferable that the polymer-molded product be longitudinally stretched along the direction in which the molded product is conveyed in the production process.

Generally, in longitudinal stretching, the number of longitudinal stretching steps and the stretching speed can be adjusted by a combination of rolls and a difference in speed of rolls.

The number of longitudinal stretching steps is not particularly limited, as long as it is one step or more. However, in terms of capability of stretching more stably at high speed and the restriction of yield and the machine used in the production, it is preferable that the polymer-molded product be longitudinally stretched through 2 or more stretching steps. In addition, stretching the polymer-molded product through 2 or more stretching steps is advantageous in that after confirmation of occurrence of nicking in the first stretching step, voids can be formed by the second stretching step.

Note that the stretching conditions in the second stretching step (e.g., stretching speed, and stretching temperature) may be identical to or different from the stretching conditions in the first stretching step.

### —Stretching Speed—

The stretching speed in the longitudinal stretching is not particularly limited, as long as the yield stress (A) and the stress (L30) at an elongation of 30% in the stress-strain (elongation) curve of the polymer-molded product in the stretching in the one axial direction satisfy the above Relationship (I) or the yield stress (A) and the stress (L40) at an elongation of 40% in the stress-strain curve in the stretching in the one axial direction satisfy the above Relationship (II), and the stress (B) at a change point and the stress (L40) at the elongation of 40% in the stress-strain curve satisfy the above Relationship (III), where the change point is a point at which the stress starts rising for the first time after falling from the yield stress (A), and may be suitably selected in accordance with the intended use. The stretching speed is, however, preferably 10 mm/min to 36,000 mm/min, more preferably 800 mm/min to 24,000 mm/min, and particularly preferably 1,200 mm/min to 12,000 mm/min. When the stretching speed is 10 mm/min or higher, it is preferable in that sufficient necking is easily caused. When the stretching speed is 36,000 mm/min or lower, it is preferable in that the polymer-molded product is uniformly stretched with ease, the resin is hardly ruptured, and the costs can be reduced without the necessity of a large-scale stretching machine intended for high-speed stretching. Therefore, when the stretching speed is 10 mm/min to 36,000 mm/min, it is preferable in that sufficient necking is easily caused, the polymer-molded product is uniformly stretched with ease, the resin is hardly ruptured, and the costs can be reduced without the necessity of a large-scale stretching machine intended for high-speed stretching.

More specifically, the stretching speed in the first stretching step is preferably 1,000 mm/min to 36,000 mm/min, more preferably 1,100 mm/min to 24,000 mm/min, and particularly preferably 1,200 mm/min to 12,000 mm/min.

In the case of 2-step stretching, it is preferably that the first stretching step be preliminary stretching mainly intended to cause necking in the polymer-molded product. The stretching speed in the preliminary stretching is preferably 10 mm/min to 300 mm/min, more preferably 40 mm/min to 220 mm/min, and particularly preferably 70 mm/min to 150 mm/min.

Then, in the 2-step stretching, the stretching speed of the second stretching step after necking is caused to take place in the preliminary stretching (first stretching step) preferably differs from the stretching speed in the preliminary stretching step. The stretching speed of the second stretching step after necking is caused to take place through the preliminary stretching is preferably 600 mm/min to 36,000 mm/min, more preferably 800 mm/min to 24,000 mm/min, and particularly preferably 1,200 mm/min to 15,000 mm/min.

The method of measuring the stretching speed is not particularly limited and may be suitably selected from among known methods. For example, the stretching speed can be measured by the following methods.

In a batch method, the moving speed of cramps pinching the end portions of the polymer-molded product when the cramps move toward the stretching direction, that is, the moving distance of the cramps/the time (mm/min) required for the moving of the cramps is defined as the stretching speed. The stretching speed defined in the present embodiment is a stretching speed in the case of the batch method, unless otherwise specified.

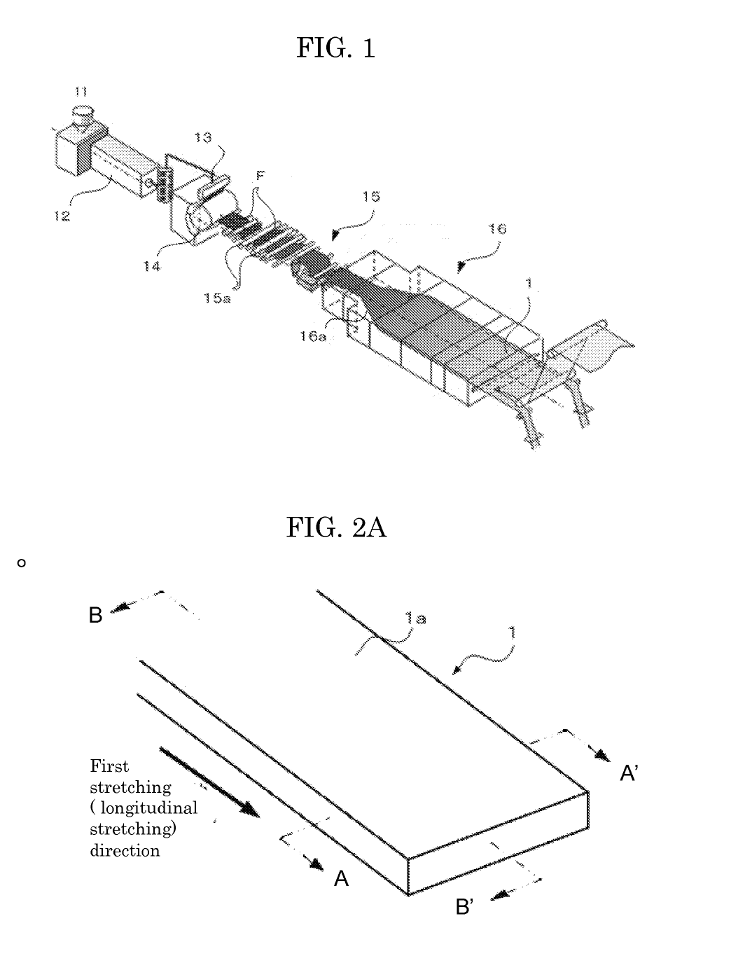

Further, in the case where the polymer-molded product is stretched by a difference in surface speed of two pairs (or two or more pairs) of nip rolls when the polymer-molded product passes these nip rolls (generally, referred to as “Roll-to-Roll stretching”), the pinched positions of the polymer-molded product are fixed by the nip rolls and thus the polymer-molded product does not move. Therefore, in the case of the Roll-to-Roll stretching, multiplying factor of the polymer-molded product being stretched/time required for stretching (% /min), is regarded as the stretching speed. Not that the nip rolls correspond to rolls 15a in FIG. 1.

The stretching speed in the batch method and the stretching speed in the Roll-to-Roll stretching can be converted to each other by measuring the length (mm) of the unstretched polymer-molded product and the length of the stretched polymer-molded product. An example where the stretching speed in a batch method is converted to the stretching speed in Roll-to-Roll stretching is shown in Table 1.

TABLE 1

| | Calculation | Example | Example |
|---|---|---|---|
| | formula | 1 | 2 |
| Stretching speed in batch method | — | 10 | 36,000 |
| (mm/min): A | | | |
| Length of unstretched | — | 110 | 110 |
| polymer-molded product (mm): B | | | |
| Length of stretched | — | 330 | 330 |
| polymer-molded product (mm): C | | | |
| Difference in length of before/after | C − B | 220 | 220 |
| stretching (mm) | | | |
| Length of polymer-molded product | 100 | 100 | 100 |
| before stretching (%) | | | |
| Length of polymer-molded product | (C/B) × 100 | 300 | 300 |
| after stretching (%) | | | |
| Difference in length of before/after | (C/B − 1) × 100 | 200 | 200 |
| stretching (%) | | | |
| Time required for stretching (min) | (C − B)/A | 22 | 0.006 |
| Stretching speed in Roll-to-Roll | Difference in | 9 | 33,333 |
| stretching (%/min) | length | | |
| | before/after | | |
| | stretching (%)/ | | |
| | Time required for | | |
| | stretching (min) | | |

### ——Stretching Temperature——

The temperature employed at the time of stretching is not particularly limited, as long as the yield stress (A) and the stress (L30) at an elongation of 30% in the stress-strain (elongation) curve of the polymer-molded product in the stretching in the one axial direction satisfy the above Relationship (I) or the yield stress (A) and the stress (L40) at an elongation of 40% in the stress-strain curve in the stretching in the one axial direction satisfy the above Relationship (II), and the stress (B) at a change point and the stress (L40) at the elongation of 40% in the stress-strain curve satisfy the above Relationship (III), where the change point is a point at which the stress starts rising for the first time after falling from the yield stress (A), and may be suitably selected in accordance with the intended use.

When the stretching temperature is represented by T (° C.) and the glass transition temperature of the polymer having crystallinity is represented by Tg (° C.), the polymer-molded product is preferably stretched at a stretching temperature T (° C.) within the range represented by (Tg−30) (° C.)≦T (° C.)≦(Tg+50) (° C.), more preferably within the range represented by (Tg−25) (° C.)≦T (° C.)≦(Tg+50) (° C.), and particularly preferably within the range represented by (Tg−20) (° C.)≦T (° C.)≦(Tg+50) (° C.).

Generally, the higher the stretching temperature (° C.), the lower the stretching tension is suppressed, and the object can be easily stretched. When the stretching temperature (° C.) is in the range of [glass transition temperature (Tg)−30]° C. to [glass transition temperature (Tg)+50]° C., it is preferable in that the void content rate is increased, the aspect ratio easily becomes 10 or more, and voids are sufficiently created.

Here, the stretching temperature T (° C.) can be measured by a non-contact type thermometer. The glass transition temperature Tg (° C.) can be measured by a differential scanning calorimeter (DSC).

In the stretching step, the polymer-molded product may be laterally stretched within the range not impairing the creation of voids, and the lateral stretching may not be carried out. When the polymer-molded product may be laterally stretched, the film may be slacken utilizing the lateral stretching step and subjected to heating treatment.

The void-containing resin molded product after being stretched may be further subjected to treatments, such as the molded product is heated to be thermally shrunk, and a tension is applied thereto.

The method of producing the polymer-molded product is not particularly limited and may be suitably selected in accordance with the intended use. For example, in the case where the crystalline polymer is a polyester resin or polyolefin resin, the polymer-molded product can be favorably produced by a melt film forming method.

The production of the polymer-molded product may be carried out individually from the stretching step or may be carried out continuously.

FIG. 1 is a view illustrating one example of a method for producing a void-containing resin molded product according to the present invention, and is a flow view of a biaxial stretching film production device. The biaxial stretching film production device illustrated in FIG. 1 is a film production device for carrying out Roll-to-Roll stretching.

As illustrated in FIG. 1, a starting material resin (polymer composition) 11 is thermally melted and kneaded inside an extruder 12 (a biaxial extruder or a uniaxial extruder is used depending on the shape of the starting material and the production scale) and then discharged in the form of a soft plate (film-shape or sheet-shape) from a T-die 13.

Next, a discharged film or sheet F is cooled and solidified on a casting drum 14 and formed into a film. The formed film or sheet F (which corresponds to “polymer-molded product”) is fed to a longitudinal stretching machine 15.

Then, the formed film or sheet F is heated again in the longitudinal stretching machine 15 and longitudinally stretched between rolls 15a which rotates at a different speed. By this longitudinal stretching, voids are formed inside the film or sheet F, along the stretching direction. Then, the film or sheet F, in which the voids are formed, is pinched, at its both ends, by clips 16a provided at right side and left side of the lateral stretching machine 16 and laterally stretched while being fed toward a film winder (not illustrated) to be a void-containing resin molded product 1. Note that in the above process, the film or sheet F which has been subjected to only longitudinal stretching may be directly used as the void-containing resin molded product 1 without providing treatment in the lateral stretching machine 16.

### <Void-Containing Resin Molded Product>

The void-containing resin molded product of the present invention can be obtained by the method for producing a void-containing resin molded product described above.

The void-containing resin molded product is formed of the polymer-molded product.

The shape of the void-containing resin molded product is not particularly limited and may be suitably selected in accordance with the intended use. For example, film-shape, sheet-shape, and fabric shape are exemplified.

### —Void—

The void-containing resin molded product of the present invention contains lengthy voids inside thereof in a state where the length direction of the voids are oriented in one direction, and is characterized by a void content rate and an aspect ratio of the voids.

The term “voids” means domains in a vacuum state or domains of gas phase present inside of the resin molded product.

The term “void content rate” means a total volume of voids contained in the resin molded product with respect to the sum of a total volume of solid-state portions of the resin molded product and the total volume of the voids.

The void content rate is not particularly limited, as long as the effects of the present invention are not impaired, and may be suitably selected in accordance with the intended use. It is preferably 3% by volume to 50% by volume, more preferably 5% by volume to 40% by volume, and particularly preferably 10% by volume to 30% by volume.

Here, the void content rate can be calculated based on a measured specific gravity.

Specifically, the void content rate can be determined by the following equation (1):

Void content rate (%)={1−(Density of void-containing resin molded product after being stretched)/(Density of polymer-molded product before being stretched)} (1)

The term “aspect ratio” means an L/r ratio, where r (μm) denotes an average length of the voids in the thickness direction orthogonal to the orientation direction of the voids, and L (μm) denotes an average length of the voids in the orientation direction of the voids.

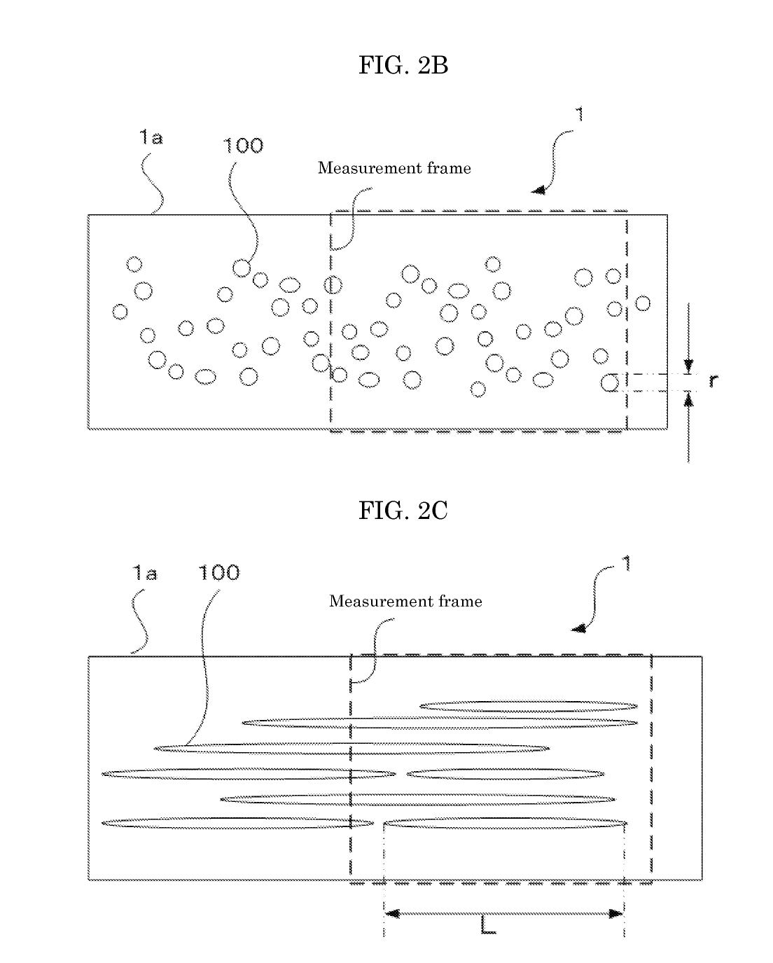

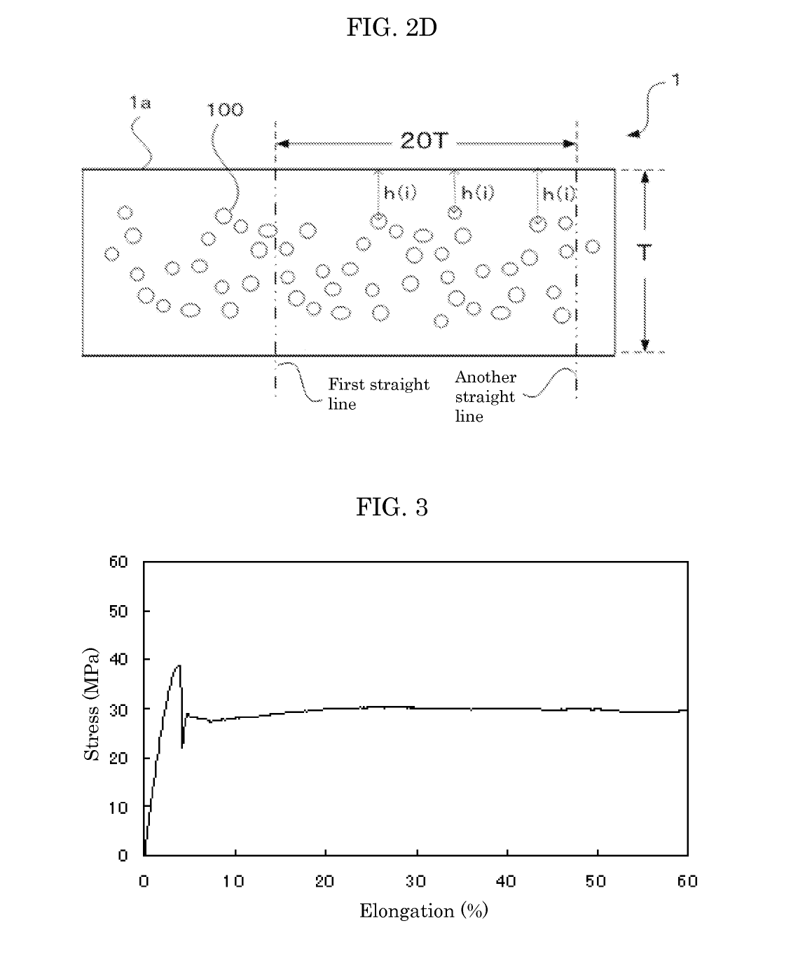

The aspect ratio is not particularly limited, as long as the effects of the present invention are not impaired, and may be suitably selected in accordance with the intended use. It is preferably 10 or more, more preferably 15 or more, and particularly preferably 20 or more. FIGS. 2A to 2C are views for specifically illustrating the aspect ratio. FIG. 2A is a perspective view of a void-containing resin molded product, FIG. 2B is a cross-sectional view the void-containing resin molded product at the A-A′ cross-section in FIG. 2A, and FIG. 2C is a cross-sectional view of the void-containing resin molded product at the B-B′ cross-section in FIG. 2A.

In the production process of the void-containing resin molded product, the voids are generally oriented along a first stretching direction. Accordingly, the “average length (r (μm)) of the voids in the thickness direction orthogonal to the orientation direction of the voids” corresponds to an average thickness r (see FIG. 2B) of voids 100 in a cross-section (A-A′ cross-section in FIG. 2A) perpendicular to a surface 1a of the void-containing resin molded product 1 and formed at right angle to the first stretching direction. The “average length (L (μm)) of the voids in the orientation direction of the voids” corresponds to an average length L (see FIG. 2C) of the voids 100 in a cross-section (B-B′ cross-section in FIG. 2A) in parallel with the first stretching direction.

Note that the first stretching direction indicates, when the stretching is performed in only one axial direction, the direction of the one axial direction. Generally, longitudinal stretching is carried out along in a direction in which a molded product flows in the production process, and thus the longitudinal direction corresponds to the first stretching direction.

When the stretching is biaxial or more multiaxial stretching, the first stretching direction indicates at least one direction of the stretching directions intended for forming voids. Usually, even in biaxial or more multiaxial stretching, longitudinal stretching is carried out along a direction in which a molded produce flows in the production process, and voids can be formed by this longitudinal stretching, and thus this longitudinal direction corresponds to the first stretching direction.

Here, the average length (r (μm)) of the voids in the thickness direction orthogonal to the orientation direction of the voids can be measured by images obtained through an optical microscope or electron microscope. Similarly, the average length (L (μm)) of the voids in the orientation direction of the voids can be measured by images obtained through an optical microscope or electron microscope.

The void-containing resin molded product of the present invention is characterized by the average number of voids P in the film thickness direction, a difference in refractive index ΔN between a crystalline polymer layer and a void layer, and a product of difference in refractive index ΔN and the average number of voids P.

The number of voids in the film thickness direction means the number of voids 100 included in the film thickness direction in a cross-section (A-A′ cross-section in FIG. 2A) perpendicular to the surface 1a of the void-containing resin molded product 1 and formed at right angle to the first stretching direction.

The average number of voids P in the film thickness direction is not particularly limited, as long as the effects of the present invention are not impaired, and may be suitably selected in accordance with the intended use. The average number of voids P is preferably 5 or more, more preferably 10 or more, and still more preferably 15 or more.

Here, the number of voids in the film thickness direction can be measured by images obtained through an optical microscope or electron microscope.

The difference in refractive index ΔN means, specifically, a value of ΔN (=N1−N2), which is a difference between N1 and N2, where N1 denotes a refractive index of a crystalline polymer layer, and N2 denotes a refractive index of a void layer.

Here, refractive indices N1 and N2 of the crystalline polymer layer and void layer can be measured by an ABBE refractometer, etc.

The product of the ΔN and P is not particularly limited, as long as the effects of the present invention are not impaired, and may be suitably selected in accordance with the intended use. It is, however, preferably 3 or more, more preferably 5 or more, and particularly preferably 7 or more.

The void-containing resin molded product contains the voids in this way, thereby, it has various excellent properties, for example, in reflectance, glossiness, and thermal conductivity. In other words, by varying the aspect of voids contained in the void-containing resin molded product, the properties such as reflectance, glossiness and thermal conductivity can be controlled.

### —Glossiness—

The glossiness of the void-containing resin molded product is preferably 60 or greater, more preferably 70 or greater, and particularly preferably 80 or greater.

Here, the glossiness can be measured by a variable angle glossimeter.

### —Light Beam Transmittance—

The light beam transmittance of the void-containing resin molded product is, at a wavelength of 550 nm, preferably 0.4% or lower, more preferably 0.3% or lower, and particularly preferably 0.2% or lower.

### —Thermal Conductivity—

The thermal conductivity of the void-containing resin molded product is preferably 0.1 (W/mK) or lower, more preferably 0.09 (W/mK) or lower, and particularly preferably 0.08 (W/mK) or lower.

Further, a suitable thermal conductivity of the void-containing resin molded product can be defined as a relative value. That is, when a thermal conductivity of the void-containing resin molded product is represented by X(W/mK), and a thermal conductivity of a polymer-molded product having the same thickness as that of the void-containing resin molded product, formed of the same polymer composition as the polymer composition constituting the void-containing resin molded product and containing no void is represented by Y(W/mK), a ratio X/Y is preferably 0.27 or lower, more preferably 0.2 or lower, and particularly preferably 0.15 or lower.

Here, the thermal conductivity can be calculated by a product of measured values of thermal diffusivity, specific heat, and density. The thermal diffusivity can be typically measured by Laser Flash method (e.g., TC-7000 manufactured by SHINKU RIKO K.K.). The specific heat can be measured according to a method described in JIS K7123. The density can be calculated by measuring the mass of a certain area, and the thickness thereof.

### —Surface Smoothness—

The void-containing resin molded product contains the voids, however, inorganic fine particles, incompatible resins, inactive gasses for creating voids are not added thereto, and thus the void-containing resin molded product has excellent surface smoothness.

The surface smoothness of the void-containing resin molded product is not particularly limited and may be suitably selected in accordance with the intended use. However, the surface smoothness (Ra) is preferably 0.3 μm or lower, more preferably 0.25 μm or lower, and particularly preferably 0.1 μm or lower.

Further, in the void-containing resin molded product, voids are formed in not only the surface of the molded product but also in portions in a predetermined distance from the surface of the molded product.

That is, in a cross-section orthogonal to the orientation direction of the voids in the void-containing resin molded product, as for 10 voids positioned closest to the surface of the void-containing resin molded product from the center of void, a distance h(i) from each center to the surface of the void-containing resin molded product is calculated, and an average arithmetic value h(avg) of each of the distance values h(i) satisfies the relationship, h(avg)>T/100.

Where T denotes an average arithmetic value of thickness in the cross-section, and the ten voids (10 voids) are selected from voids present in a region sandwiched by an arbitrarily selected first straight line in parallel with the thickness direction and another straight line in parallel with the first straight line and positioned away from the first straight line by 20×T.

The term “the center of void” means the center of void when the cross-sectional shape of the void is a perfect circle, and when the cross-sectional shape of the void is a shape other than perfect circle, for example, a center of a circle where a square sum of deviation of a standard circle arbitrarily determined by the maximum square center method is determined, and the center is regarded as the center of the void.

The wording “the surface of the void-containing resin molded product” means the outermost surface of the void-containing resin molded product in the thickness direction thereof. Typically, the surface of the void-containing resin molded product means a top surface when the void-containing resin molded product is placed.

Specifically, a cross-section of the void-containing resin molded product perpendicular to the surface thereof and at a right angle in the longitudinally stretching direction (see (FIG. 2D) is observed by a scanning electron microscope at an appropriate magnification of 300 to 3,000 to take an image of the cross-section. In the cross-section image, an average arithmetic thickness value T is calculated. As the average arithmetic thickness value T, a thickness measured using a long range contact type displacement meter or the like may be used. In the thickness measurement, FILM THICKNESS TESTER KG601B manufactured by Anritsu Company can also be used.

Next, in the cross-section image, an arbitrarily selected first straight line is written in the thickness direction, and further, another straight line in parallel with the first straight line and positioned away from the first straight line by 20×T is written.

Then, in each void in the cross-section image, a center of a circle where a square sum of deviation of a standard circle arbitrarily determined by the maximum square center method is determined, and this center is regarded as the center of void.

In the region sandwiched by the first straight line and the another straight line, ten (10) voids positioned closest to the surface of the void-containing resin molded product from the center of void are selected. Note that the “distance from the center of void to the surface of the void-containing resin molded product” is a radius of a circle as follows: when a circle having the “center of void” as its center is written and the radius of a circle to be written is increased sequentially, a radius of the circle when the circular arc is contacted with the void-containing resin molded product for the first time is regarded as the radius.

Then, as for the selected 10 voids, a distance h(i) from each center of void to the surface of the void-containing resin molded product is calculated, and an average arithmetic value h(avg) of each of the distances h(i) calculated is calculated by the following Equation (2).

h(avg)=(Σh(i))/10 (2)

Note that when void-containing resin molded product has a curvature or a stress is applied thereto, the “distance h(i) from each center of void to the surface of the void-containing resin molded product” cannot be measured precisely, and thus in the measurement, it is preferable to measure the distance in a state where the void-containing resin molded produce is placed flat.

The void-containing resin molded product contains the voids, however, the voids are not formed near the surface of the void-containing resin molded product, and thus it has excellent surface smoothness.

### <Application>

The void-containing resin molded product of the present invention can be used for reflectors such as illumination members for electric appliances, household illumination members and interior sign-boards; image-receiving materials or image-receiving sheets usable for sublimation transfer recording materials or thermal transfer recording materials; various thermal insulating materials, pressure sensitive materials, agricultural multi-films, components for cosmetics, food wrapping materials, light-shielding shrink films and screens.

### EXAMPLES

Hereinafter, the present invention will be further described in detail, however, the following Examples should not be construed as limiting the scope of the present invention. Accordingly, all modifications within the present invention are included within the spirit and scope of the appended claims without deviating from the spirit and scope of the present invention described above and below.

### Example A-1

PBT1 (produced by Poly-Plastic Co., Ltd.; polybutylene terephthalate 100% resin), having IV of 0.72, was extruded from a T-die at 245° C. using a melt extruder, and solidified with a casting drum thermally controlled at 53° C. to obtain a polymer film having a thickness of about 120 μm. This polymer film was subjected to uniaxial stretching (longitudinal stretching) by roll-to-roll method.

Specifically, the polymer film was uniaxially stretched under a heating atmosphere of 43° C., the circumferential speed of the first stretching step of 0.4 m/min, and the circumferential speed of the second stretching step of 2.0 m/min. The stress-strain (elongation) curve of the polymer film is illustrated in FIG. 3.

Note that the measurement of a stress (calculation method) was carried out in accordance with a method described in JIS K 7127, the measurement of strain (elongation) was carried out in accordance with the method described in JIS K 7127.

From FIG. 3, the relationship between the yield stress (A) and the stress (L30) at an elongation of 30% was found as L30/A=0.77.

Voids were created by the stretching, and it was possible to obtain a void-containing resin film.

### Example A-2

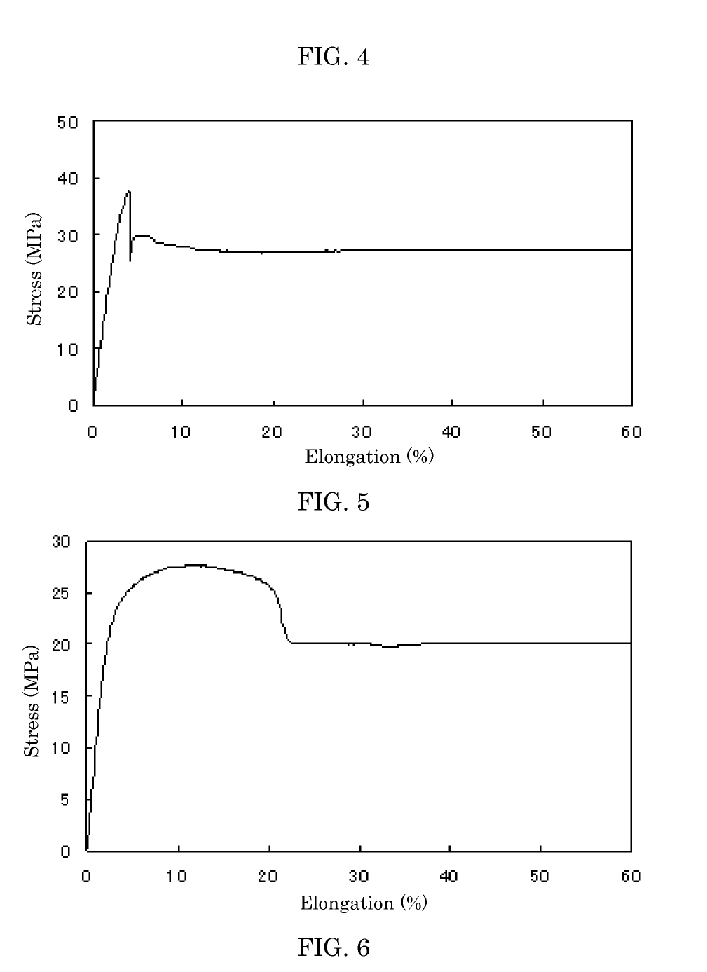

A polymer film was produced in the same manner as in Example A-1, except that the condition for stretching was changed, and the polymer film was stretched under a heating atmosphere of 30° C. The stress-strain (elongation) curve of the polymer film is illustrated in FIG. 4.

Note that the measurement of a stress (calculation method) was carried out in accordance with a method described in JIS K 7127, the measurement of strain (elongation) was carried out in accordance with the method described in JIS K 7127.

From FIG. 4, the relationship between the yield stress (A) and the stress (L30) at an elongation of 30% was determined as L30/A=0.71.

Voids were created by the stretching, and it was possible to obtain a void-containing resin film.

### Example A-3

iPP (isotactic polypropylene, PRIMEPOLYPRO J105, produced by Prime Polymer Co., Ltd.;), having MFR of 9.0 (g/10 min), was extruded from a T-die at 220° C. using a melt extruder, and solidified with a casting drum thermally controlled at 70° C. to obtain a polymer film having a thickness of about 145 μm. This polymer film was subjected to uniaxial stretching (longitudinal stretching) by roll-to-roll method.

Specifically, the polymer film was uniaxially stretched under a heating atmosphere of 30° C., the circumferential speed of the first stretching step of 0.6 m/min, and the circumferential speed of the second stretching step of 3.1 m/min. The stress-strain (elongation) curve of the polymer film is illustrated in FIG. 5.

Note that the measurement of a stress (calculation method) was carried out in accordance with a method described in JIS K 7127, the measurement of strain (elongation) was carried out in accordance with the method described in JIS K 7127.

From FIG. 5, the relationship between the yield stress (A) and the stress (L30) at an elongation of 30% was found as L30/A=0.72.

Voids were created by the stretching, and it was possible to obtain a void-containing resin film.

### Example A-4

A polymer film was produced in the same manner as in Example A-1, except that the condition for stretching was changed, and the polymer film was stretched under a heating atmosphere of 45° C. The stress-strain (elongation) curve of the polymer film is illustrated in FIG. 6.

Note that the measurement of a stress (calculation method) was carried out in accordance with a method described in JIS K 7127, the measurement of strain (elongation) was carried out in accordance with the method described in JIS K 7127.

From FIG. 6, the relationship between the yield stress (A) and the stress (L30) at an elongation of 30% was determined as L30/A=0.86.

Voids were created by the stretching, and it was possible to obtain a void-containing resin film.

### Comparative Example A-1

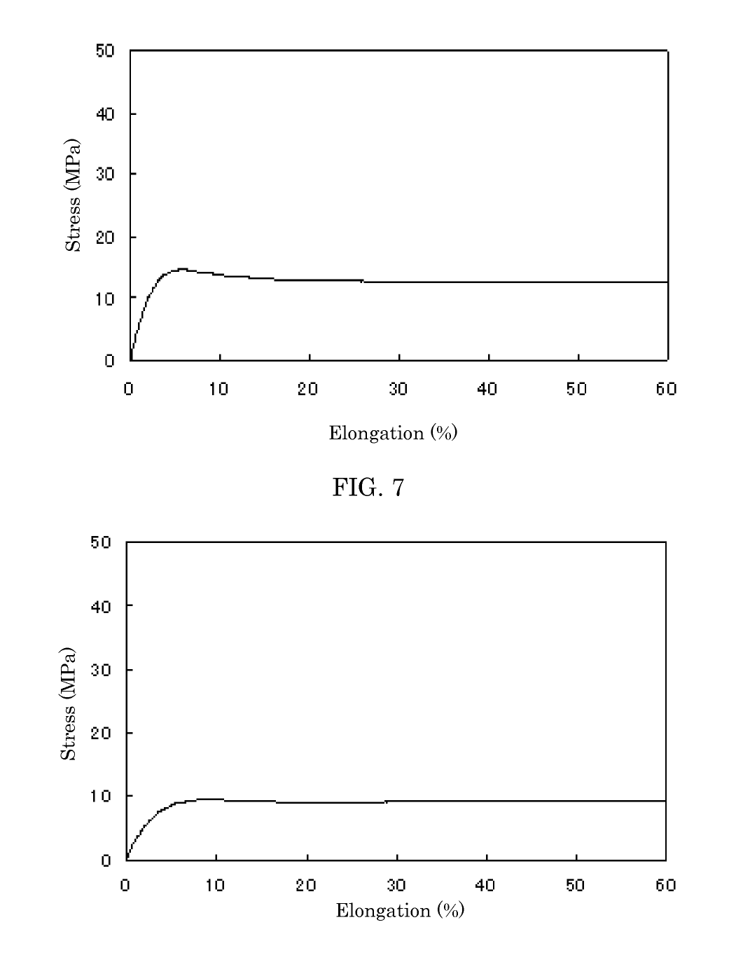

A polymer film was produced in the same manner as in Example A-1, except that the condition for stretching was changed, and the polymer film was stretched under a heating atmosphere of 70° C. The stress-strain (elongation) curve of the polymer film is illustrated in FIG. 7.

Note that the measurement of a stress (calculation method) was carried out in accordance with a method described in JIS K 7127, the measurement of strain (elongation) was carried out in accordance with the method described in JIS K 7127.

From FIG. 7, the relationship between the yield stress (A) and the stress (L30) at an elongation of 30% was determined as L30/A=0.98.

In the stretching, no void was created, and it was impossible to obtain a void-containing resin film.

### Example B-1

PBT1 (produced by Poly-Plastic Co., Ltd.; polybutylene terephthalate 100% resin), having IV of 0.72, was extruded from a T-die at 245° C. using a melt extruder, and solidified with a casting drum thermally controlled at 40° C. to obtain a polymer film having a thickness of about 127 μm. This polymer film was subjected to uniaxial stretching (longitudinal stretching) by roll-to-roll method.

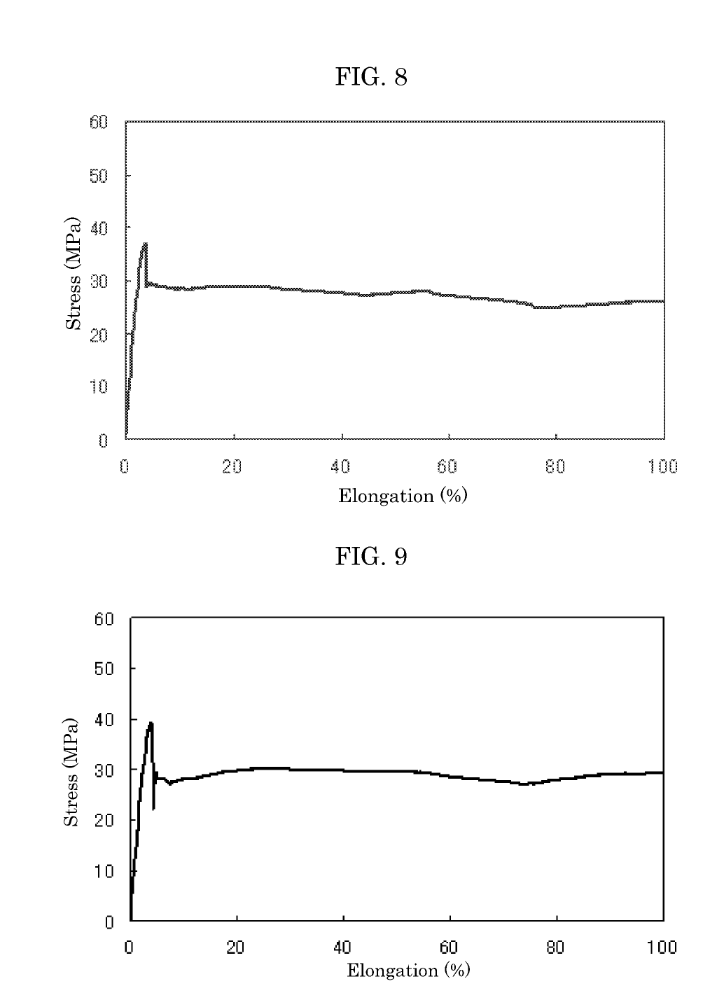

Specifically, the polymer film was uniaxially stretched under a heating atmosphere of 40° C., the circumferential speed of the first stretching step of 0.4 m/min, and the circumferential speed of the second stretching step of 2.0 m/min. The stress-strain (elongation) curve of the polymer film is illustrated in FIG. 8.

Note that the measurement of a stress (calculation method) was carried out in accordance with a method described in JIS K 7127, the measurement of strain (elongation) was carried out in accordance with the method described in JIS K 7127.

From FIG. 8, the yield stress (A) was found to be 37.1 MPa, the stress (L40) at an elongation of 40% was found to be 26.5 MPa, and A was greater than L40. In addition, the relationship between a stress (B) at a change point at which the stress starts rising for the first time after falling from the yield stress (A) and the stress (L40) at an elongation of 40% was found as B/L40=1.09.

Voids were created by the stretching, and it was possible to obtain a void-containing resin film.

### Example B-2

A polymer film was produced in the same manner as in Example B-1, except that the temperature of the casting drum was changed to 53° C. The stress-strain (elongation) curve of the polymer film is illustrated in FIG. 9.

Note that the measurement of a stress (calculation method) was carried out in accordance with a method described in JIS K 7127, the measurement of strain (elongation) was carried out in accordance with the method described in JIS K 7127.

From FIG. 9, the yield stress (A) was found to be 39.0 MPa, the stress (L40) at an elongation of 40% was found to be 29.9 MPa, and A was greater than L40. In addition, the relationship between a stress (B) at a change point at which the stress starts rising for the first time after falling from the yield stress (A) and the stress (L40) at an elongation of 40% was found as B/L40=0.74.

Voids were created by the stretching, and it was possible to obtain a void-containing resin film.

### Example B-3

iPP (isotactic polypropylene, PRIMEPOLYPRO J105, produced by Prime Polymer Co., Ltd.;), having MFR of 9.0 (g/10 min), was extruded from a T-die at 220° C. using a melt extruder, and solidified with a casting drum thermally controlled at 70° C. to obtain a polymer film having a thickness of about 150 μm. This polymer film was subjected to uniaxial stretching (longitudinal stretching) by roll-to-roll method.

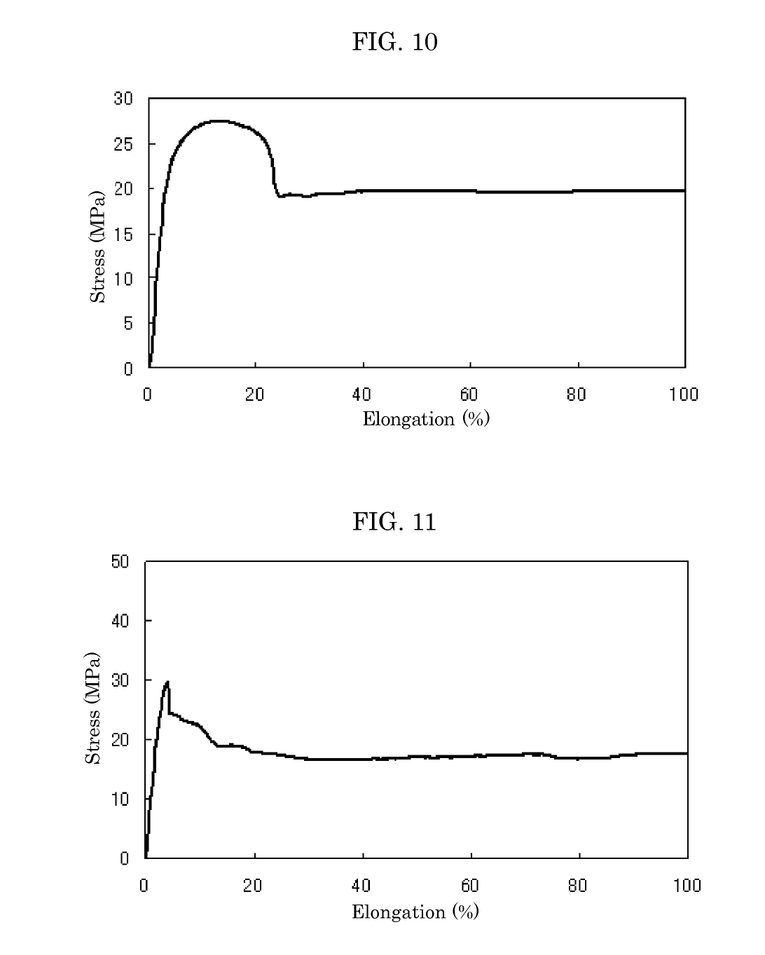

Specifically, the polymer film was uniaxially stretched under a heating atmosphere of 30° C., the circumferential speed of the first stretching step of 0.6 m/min, and the circumferential speed of the second stretching step of 3 m/min. The stress-strain (elongation) curve of the polymer film is illustrated in FIG. 10.

Note that the measurement of a stress (calculation method) was carried out in accordance with a method described in JIS K 7127, the measurement of strain (elongation) was carried out in accordance with the method described in JIS K 7127.

From FIG. 10, the yield stress (A) was found to be 27.4 MPa, the stress (L40) at an elongation of 40% was found to be 19.6 MPa, and A was greater than L40. In addition, the relationship between a stress (B) at a change point at which the stress starts rising for the first time after falling from the yield stress (A) and the stress (L40) at an elongation of 40% was found as B/L40=0.97.

Voids were created by the stretching, and it was possible to obtain a void-containing resin film.

### Comparative Example B-1

A polymer film was produced in the same manner as in Example B-1, except that the temperature of the casting drum was changed to 11° C. The stress-strain (elongation) curve of the polymer film is illustrated in FIG. 11.

Note that the measurement of a stress (calculation method) was carried out in accordance with a method described in JIS K 7127, the measurement of strain (elongation) was carried out in accordance with the method described in JIS K 7127.

From FIG. 11, the yield stress (A) was found to be 29.5 MPa, the stress (L40) at an elongation of 40% was found to be 16.7 MPa, and A was greater than L40. In addition, the relationship between a stress (B) at a change point at which the stress starts rising for the first time after falling from the yield stress (A) and the stress (L40) at an elongation of 40% was found as B/L40=1.46.

In the stretching, no void was created, and it was impossible to obtain a void-containing resin film.

### —Evaluation Method—

The void-containing resin films of Examples A-1 to A-4, and Examples B-1 to B-3 were subjected to the following evaluations. Note that the resin films of Comparative Example A-1 and Comparative Example B-1 were unable to create voids, and thus the following evaluations were not carried out. The results are shown in Tables 2 and 3.

### (1) Measurement of Thickness

The thickness of the resin film was measured using long range contact type displacement meters AF030 (measurement unit), AF350 (indication unit) manufactured by KEYENCE Corporation.

### (2) Measurement of Glossiness

The glossiness of the void-containing resin molded products obtained above was measured under the conditions of incident angle: 60° and light receiving angle: 60°, using a variable-angle glossmeter, VG-1001DP manufactured by Nippon Denshoku Industries Co., Ltd. to obtain degrees of glossiness.

### (3) Measurement of Beam Light Transmittance

A beam light transmittance (M) of the void-containing resin molded products obtained above was measured using a spectrophotometer, U-4100 (manufactured by Hitachi Ltd.) as follows.

A light beam was inclined at 5° from the perpendicular direction to the surface of the void-containing resin film to be incident on the film surface, and the intensity of the light beam transmitting to the void-containing resin film was compared with a blank value of which no void-containing resin film was placed. As for the wavelength, 550 nm was used.

In addition, similarly to the above, a transmittance (N) of a polymer-molded product formed of the same crystalline polymer as the crystalline polymer constituting the void-containing resin molded product and containing no void was measured in the same thickness of that of the void-containing resin molded product.

### (4) Measurement of Thermal Conductivity

The thermal diffusivity of each resin film was measured using TC-7000 (manufactured by SHINKU RIKO K.K.). Both surfaces of each resin film was colored in black and then the thermal conductivity was measured at room temperature. The density and specific heat were measured the method described below, and the thermal conductivity was determined from the product of three measurement values.

### (5) Measurement of Density

A portion in a certain area was cut out from each resin film, the mass thereof was measured by a balance, the thickness thereof was measured by a film thickness meter, and the mass was divided by the volume to thereby determine the density.

### (6) Measurement of Specific Heat

The specific heat of each resin film was determined by a method described in JIS K7123. Q1000 (TA Instruments Corp.) was used as a DSC.

### (7) Measurement of Surface Smoothness

The surface smoothness was measured through an objective lens at a magnification of 50, using a light-interference three-dimensional shape analyzer, NEWVIEW 5022 (manufactured by Zygo Co.).

### (8) Measurement of Void Content Rate

The void content rate was calculated based on the specific gravity.

Specifically, the void content rate was calculated by the following Equation (1).

Void content rate (%)={1−(density of resin film after being stretched)/(density of polymer film before being stretched)} Equation (1)

### (9) Measurement of Aspect Ratio

A cross-section of each resin film perpendicular to the surface of the resin film and being at right angle in the longitudinal stretching direction (see FIG. 2B) and a cross-section perpendicular to the surface of the resin film and in parallel to the longitudinal stretching direction (see FIG. 2C) were observed through a scanning electron microscope at an appropriate magnification of 300 to 3,000, and a measurement flame was defined in each of the cross-section images. This measurement flame was set so that 50 to 100 voids were included in the flame. By the observation through the scanning electron microscope, it was confirmed that the voids were oriented along the longitudinal stretching direction.

Next, the number of voids included in the measurement flame was counted, the number of voids included in the measurement flame (see FIG. 2B) of the cross-section perpendicular to the longitudinal stretching direction was defined as “m”, and the number of voids included in the measurement flame (see FIG. 2C) of the cross-section in parallel with the longitudinal stretching direction was defined as “n”.

Then, a thickness (rᵢ) of each void included in the measurement flame (see FIG. 2B) of the cross-section perpendicular to the longitudinal stretching direction was measured, and an average thickness was defined as “r”. Further, a thickness (Lᵢ) of each void included in the measurement flame (see FIG. 2C) included in the measurement flame (see FIG. 2C) of the cross-section in parallel with the longitudinal stretching direction was measured, and an average length was defined as “L”.

“r” and “L” can be expressed by the following equations (3) and (4):

r=(Σrᵢ)/m (3)

L=(ΣLᵢ)/n (4)

Then, L/r was calculated to determine an aspect ratio.

(10) Measurement of Distance from Void Arranged at the Closest Position of Film Surface to the Film Surface

A cross-section (see FIG. 2D) of each resin film perpendicular to the surface of the resin film and at a right angle in the longitudinal stretching direction was observed through a scanning electron microscope at an appropriate magnification of 300 to 3,000 to take a cross-section image.

In the imaging, the resin film was placed on the scanning electron microscope in a state where the resin film is placed flat, and then an image thereof was taken.

In the cross-section image, an average arithmetic value T of thickness was calculated The average arithmetic value T of thickness calculated in each resin film was found to be the same as the thickness measured in “(1) Measurement of Thickness” (see Table 2) described above.

Next, in the cross-section image, an arbitrarily selected first straight light in parallel with the thickness direction was written, and further, another straight line in parallel with the first straight line and positioned away from the first straight line by 20×T was written. By the observation through the scanning electron microscope, voids are oriented along the longitudinal stretching direction.

In the region sandwiched by the first straight line and the another straight line, ten (10) voids positioned closest to the surface of the void-containing resin molded product from the center of void are selected. Note that the “distance from the center of void to the surface of the void-containing resin molded product” is a radius of a circle as follows: when a circle having the “center of void” as its center is written and the radius of a circle to be written is increased sequentially, a radius of the circle when the circular arc is contacted with the void-containing resin molded product for the first time is regarded as the radius.

Then, as for the selected 10 voids, a distance h(i) from each center of void to the surface of the void-containing resin molded product is calculated, and an average arithmetic value h(avg) of each of the distances h(i) calculated is calculated by the following Equation (2).

h(avg)=(Σh(i))/10 (2)

### (11) Average Number of Voids P Arranged in Thickness Direction

First, an image of a cross-section of each void-containing resin film perpendicular to the surface of the void-containing resin film and at right angle in the longitudinal stretching direction was taken.

Then, a straight line was written in the film thickness direction (from the bottom surface of the film to the top surface thereof) in the cross-section image, and the number of voids in contact with the straight line was counted. This process was carried out on 20 straight lines, and an average value thereof was determined.

(12) Difference in Refractive Index ΔN between Crystalline Polymer Layer and Void Layer

A refractive index N1 of each crystalline polymer layer and a refractive index N2 of each void layer were measured by an Abbe refractometer, and a difference therebetween, ΔN(=N1−N2) was calculated.

TABLE 2

| | Example | Example | Example | Example |
|---|---|---|---|---|
| | A-1 | A-2 | A-3 | A-4 |
| Outline view of void- | silver | silver | silver | silver |
| containing resin film | | | | |
| Thickness of void- | 30 | 32 | 45 | 12 |
| containing resin film (μm) | | | | |
| Glossiness of void- | 114 | 110 | 113 | 104 |
| containing resin film | | | | |
| Light beam transmittance | 0.2 | 0.21 | 0.14 | 0.3 |
| M (%) at 550 nm of | | | | |
| void-containing resin film | | | | |
| Light beam transmittance | 78 | 78 | 87 | 78 |
| N (%) at 550 nm of | | | | |
| polymer film containing | | | | |
| no void and having | | | | |
| the same length as | | | | |
| void-containing resin film | | | | |
| M/N | 0.0026 | 0.0027 | 0.0016 | 0.0038 |
| Thermal conductivity | 0.048 | 0.030 | 0.028 | 0.063 |
| of void-containing resin | | | | |
| film X(W/mK) | | | | |
| Thermal conductivity | 0.35 | 0.35 | 0.17 | 0.35 |
| of polymer film | | | | |
| containing no void and | | | | |
| having the same length as | | | | |
| void-containing resin | | | | |
| film Y(W/mK) | | | | |
| X/Y | 0.14 | 0.09 | 0.16 | 0.18 |
| Density | 0.95 | 0.94 | 0.61 | 1.03 |
| Specific heat | 1.63 | 1.43 | 1.59 | 1.62 |
| Surface smoothness (Ra) | 0.03 | 0.03 | 0.04 | 0.03 |
| Void content (% by | 27 | 28 | 34 | 21 |
| volume) | | | | |
| Average void thickness | 0.84 | 0.85 | 0.64 | 0.98 |
| r (μm) | | | | |
| Average void length | 11.7 | 19 | 13.8 | 15.2 |
| L (μm) | | | | |
| L/r | 13.9 | 22.5 | 22.2 | 15.5 |
| h (avg) | 7 | 5 | 0.8 | 9 |
| P | 25 | 23 | 18 | 15 |
| ΔNxP | 13 | 12 | 9 | 8 |

The results shown in Table 2 demonstrated that the void-containing resin films of Examples A-1 to A-4 contained voids formed of only crystalline polymer. Further, in the void-containing resin films of Examples A-1 to A-4, void creation agent (component which increases the thermal conductivity) such as thermoplastic resins and inorganic fine particles were not present in void parts, and thus the thermal conductivity of the void-containing resin films was small, and greatly reduced as compared to the thermal conductivity of the resin film before being stretched (X/Y ratio is small).

Based on the unexpected results of generating voids only inside of the void-containing resin molded product, it was also found that the surface smoothness of the void-containing resin molded product is greatly excellent.

TABLE 3

| | Example | Example | Example |
|---|---|---|---|
| | B-1 | B-2 | B-3 |
| Outline view of void-containing | silver | silver | silver |
| resin film | | | |
| Thickness of void-containing resin | 27 | 32 | 48 |
| film (μm) | | | |
| Glossiness of void-containing resin | 106 | 116 | 115 |
| film | | | |
| Light beam transmittance M (%) at | 0.21 | 0.18 | 0.15 |
| 550 nm of void-containing resin film | | | |
| Light beam transmittance N (%) at | 88 | 88 | 87 |
| 550 nm of polymer film containing no | | | |
| void and having the same length as | | | |
| void-containing resin film | | | |
| M/N | 0.0024 | 0.002 | 0.0017 |
| Thermal conductivity of void- | 0.046 | 0.036 | 0.030 |
| containing resin film X(W/mK) | | | |
| Thermal conductivity of polymer | 0.35 | 0.35 | 0.17 |
| film containing no void and | | | |
| having the same length as | | | |
| void-containing resin film Y(W/mK) | | | |
| X/Y | 0.13 | 0.10 | 0.17 |
| Density | 0.93 | 0.91 | 0.62 |
| Specific heat | 1.61 | 1.25 | 1.63 |
| Surface smoothness (Ra) | 0.03 | 0.03 | 0.04 |
| Void content (% by volume) | 32 | 34 | 30 |
| Average void thickness r (μm) | 0.82 | 0.84 | 0.63 |
| Average void length L (μm) | 12.6 | 18.9 | 14.2 |
| L/r | 15.4 | 22.5 | 22.5 |
| h (avg) | 7 | 4 | 0.7 |
| P | 24 | 11 | 18 |
| ΔNxP | 12 | 6 | 9 |

The results shown in Table 3 demonstrated that the void-containing resin films of Examples B-1 to B-3 contained voids formed of only crystalline polymer. In addition, it was found that the void-containing resin films of Examples B-1 to B-3 effectively block light and exhibit excellent reflecting properties and glossiness. Furthermore, it was found that in the void-containing resin films of Examples B-1 to B-3, void creation agents (components increasing the thermal conductivity) such as thermoplastic resins and inorganic fine particles were not present in void parts, and thus they had small thermal conductivity, and the thermal conductivity after being stretched was greatly reduced as compared to that before being stretched (X/Y ratio is small).

Based on the unexpected results of generating voids only inside of the void-containing resin molded product, it was also found that the void-containing resin films have greatly excellent surface smoothness.

### INDUSTRIAL APPLICABILITY

Since the void-containing resin molded product of the present invention contains voids, it can be used for reflectors such as illumination members for electric appliances, household illumination members and interior sign-boards; image-receiving materials or image-receiving sheets usable for sublimation transfer recording materials or thermal transfer recording materials; various thermal insulating materials, pressure sensitive materials, agricultural multi-films, components for cosmetics, food wrapping materials, light-shielding shrink films and screens.

### REFERENCE SIGNS LIST

1 Void-containing resin molded product

1a Surface

11 Starting material

12 Biaxial extruder/uniaxial extruder

13 T-die

14 Casting drum

15 Longitudinal stretching machine

15a Roll

16 Lateral stretching machine

16a Clip

100 Void

F Film or sheet

L Length of void in aspect ratio

r Thickness of void in aspect ratio

1-4. (canceled)

5. A method for producing a void-containing resin molded product, the method comprising:
stretching a polymer-molded product containing a single crystalline polymer in at least one axial direction,
wherein a yield stress (A) and a stress (L30) at an elongation of 30% in a stress-strain curve of the polymer-molded product in the stretching in the one axial direction satisfy Relationship (I) below:
L30/A<0.90 Relationship (I)

6. A method for producing a void-containing resin molded product, the method comprising:
stretching a polymer-molded product containing a single crystalline polymer in at least one axial direction,
wherein a yield stress (A) and a stress (L40) at an elongation of 40% in a stress-strain curve of the polymer-molded product in the stretching in the one axial direction satisfy Relationship (II) below, and a stress (B) at a change point and the stress (L40) at the elongation of 40% in the stress-strain curve satisfy Relationship (III) below, where the change point is a point at which the stress starts rising for the first time after falling from the yield stress (A):
A>L40 Relationship (II)
B/L40≦1.40 Relationship (III)

7. The method for producing a void-containing resin molded product according to claim 5, wherein the crystalline polymer is any one of polyolefin, polyester, and polyamide.

8. The method for producing a void-containing resin molded product according to claim 6, wherein the crystalline polymer is any one of polyolefin, polyester, and polyamide.

9. A void-containing resin molded product obtained by a method for producing a void-containing resin molded product, wherein the method comprises:
stretching a polymer-molded product containing a single crystalline polymer in at least one axial direction,
wherein a yield stress (A) and a stress (L30) at an elongation of 30% in a stress-strain curve of the polymer-molded product in the stretching in the one axial direction satisfy Relationship (I) below:
L30/A<0.90 Relationship (I)

10. A void-containing resin molded product obtained by a method for producing a void-containing resin molded product, wherein the method comprises:
stretching a polymer-molded product containing a single crystalline polymer in at least one axial direction,
wherein a yield stress (A) and a stress (L40) at an elongation of 40% in a stress-strain curve of the polymer-molded product in the stretching in the one axial direction satisfy Relationship (II) below, and a stress (B) at a change point and the stress (L40) at the elongation of 40% in the stress-strain curve satisfy Relationship (III) below, where the change point is a point at which the stress starts rising for the first time after falling from the yield stress (A):
A>L40 Relationship (II)
B/L40≦1.40 Relationship (III)

11. The void-containing resin molded product according to claim 9, wherein the crystalline polymer is any one of polyolefin, polyester, and polyamide.

12. The void-containing resin molded product according to claim 10, wherein the crystalline polymer is any one of polyolefin, polyester, and polyamide.
